(19) United States
(12) Patent Application Publication
(10) Pub. No.: US 2003/0071893 A1
(43) Pub. Date: Apr. 17, 2003

(54) System and method of providing visual documentation during surgery

(76) Inventors: David Miller, Brookline, MA (US); Ernesto Blanco, Belmont, MA (US); Steve K. Burns, Durham, NH (US); Ramgopol Rao, Irvine, CA (US); Robert Stegmann, Pretoria (ZA)

Correspondence Address: BROMBERG & SUNSTEIN LLP, 125 SUMMER STREET, BOSTON, MA, 02110-1618, US

(21) Appl. No.: 10/265,303

(22) Filed: Oct. 4, 2002

Related U.S. Application Data
(60) Provisional application No. 60/327,323, filed on Oct. 5, 2001.
(60) Provisional application No. 60/348,545, filed on Jan. 16, 2002.

(51) Int. Cl. H04N 15/00

(52) U.S. Cl. 348/42; 348/584; 382/128

(57) ABSTRACT

A method of providing visual documentation of a surgical procedure. The method includes providing at least one video camera for generating a video signal in a digital format, the video signal representative of a stereoscopic view pair of a surgical subject. A template is created having a graphical content pertinent to the subject of the stereoscopic view pair. The template is displayed such that the template is overlaid contemporaneously with the stereoscopic view pair.

### CROSS REFERENCE TO RELATED APPLICATIONS

This application claims priority from both U.S. provisional patent application serial No. 60/327,323, filed Oct. 5, 2001, entitled “An Intelligent Opthalmic Microsurgical System” and U.S. provisional patent application serial No. 60/348,545, filed Jan. 16, 2002, entitled “A Failsafe, Multiview, Electro-optical, Cluster for Ophthalmic Microsurgery.” Each of the patent applications described in this paragraph is hereby incorporated by reference, in its entirety.

### TECHNICAL FIELD AND BACKGROUND ART

The present invention relates to a method and device for providing visual documentation pertaining to a surgical procedure, and more particularly, to displaying a template overlaid contemporaneously with a stereoscopic view of the surgical procedure.

During an ophthalmic surgical procedure using a standard operating microscope, a surgeon may need to make various measurements, such as incision length, the size of an anatomic structure, or distance between anatomic structures. Such measurements are either done by superimposing a reticle in the eyepiece over the area under consideration, or by using a ruler and making a direct measurement in the field of operation. In both cases, the operator often must estimate if the edge of the structure measured falls between the marks on the ruler or on the reticle.

Additionally, during the ophthalmic surgical procedure, the surgeon often marks areas to be excised or sutured with an inked marker. During the operation, the ink tends to be washed away because of frequent irrigations necessary to keep the surface of the eye moist, making such excisions or sutures difficult.

Furthermore, either when operating alone or with an assistant, a surgeon may need advice pertaining to the surgical procedure, such as when performing a new or complicated operation or when facing an unexpected complication. It is important that such advice be provided in a timely and reliable manner. Advisors in remote locations may not be able to observe the surgical subject, making it difficult to provide advice. Additionally, the level of expertise available may not be able to provide proper guidance.

### SUMMARY OF THE INVENTION

In a first embodiment of the invention there is provided a method and a computer program product for providing visual documentation of a surgical procedure. The method includes providing at least one video camera for generating a video signal in a digital format, the video signal representative of a stereoscopic view pair of a surgical subject. A template is created having a graphical content pertinent to the subject of the stereoscopic view pair. The template is displayed such that the template is overlaid contemporaneously with the stereoscopic view pair.

In a related embodiment of the invention, creating the template includes incorporating measurement information pertinent to the surgical subject into the template. Incorporating measurement information may include calculating a distance and/or an elevation pertinent to the surgical subject.

In another related embodiment of the invention, creating the template includes incorporating reference material pertinent to the surgical procedure into the template. Incorporating reference material may include storing a plurality of selectable videos on a storage medium, selecting one of the plurality of selectable videos, and incorporating the selected one of the plurality of selectable videos into the template. The plurality of selectable videos may be stored in one of a semiconductor device, an optical device, and a magnetic device. The optical device may be one of a Compact Disk and a Digital Versatile Disk. The plurality of selectable videos may include a video that provides a tutorial on the surgical procedure or that provides guidance pertaining to a surgical complication that may arise.

In other related embodiments of the invention, creating the template may include incorporating surgical advice pertinent to the surgical subject into the template. Such advice may be interpretive. Incorporating surgical advice may include, for example, providing pattern recognition. Creating the template may include incorporating a selectable suturing pattern into the template, the selectable suturing pattern superposed on the stereoscopic view pair. Displaying the template overlaid contemporaneously with the stereoscopic view pair may include displaying a plurality of display windows on one or more displays. Audio pertinent to the surgical subject may be provided.

In still other related embodiments, the method includes illuminating the surgical subject with a light emitting diode. A slit lamp or an opthalmoscope may also be utilized.

### BRIEF DESCRIPTION OF THE DRAWINGS

The foregoing features of the invention will be more readily understood by reference to the following detailed description, taken with reference to the accompanying drawings, in which:

FIG. 1 is a block diagram of a stereoscopic surgical microscopic system 100, in accordance with one embodiment of the invention;

FIG. 2 is a pictorial view of an operating table equipped with a stereoscopic surgical microscopic system, in accordance with one embodiment of the invention;

FIG. 3 is a cross-sectional view of a slit lamp used in conjunction with a stereoscopic video camera, in accordance with one embodiment of the invention;

FIG. 4 shows a cross-sectional view of an ophthalmoscope used in conjunction with a stereoscopic video camera, in accordance with one embodiment of the invention; and

FIG. 5 shows a sample template that incorporates a stereoscopic view pair, in accordance with one embodiment of the invention.

### DETAILED DESCRIPTION OF SPECIFIC EMBODIMENTS

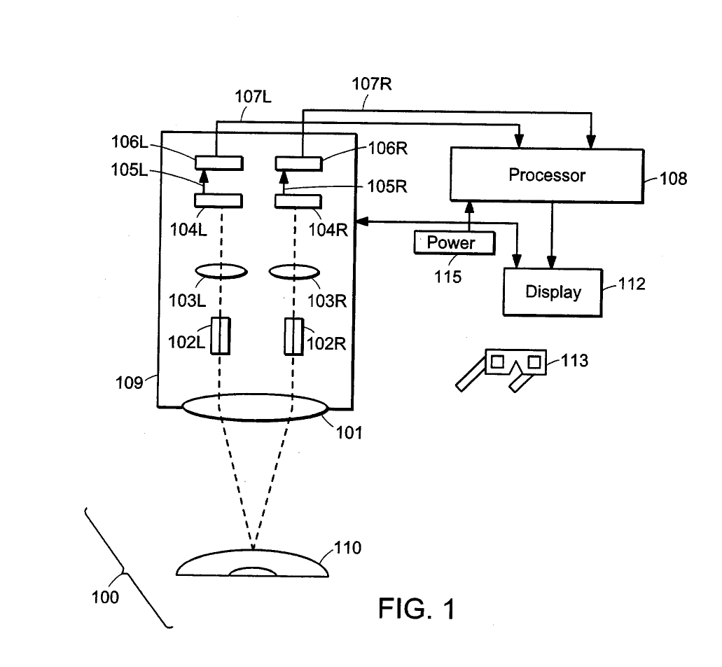

FIG. 1 is a block diagram of a stereoscopic surgical microscopic system 100, in accordance with one embodiment of the invention. Such a system may be used in, but not limited to, ophthalmic surgery, cerebral surgery, cosmetic surgery, and ear, nose and throat surgery. The system includes at least one stereoscopic video camera 109 for generating a video signal(s) representing a stereoscopic view pair of a surgical subject 110. The video signal is provided to one or more displays 112. An intelligence component, which may include, without limitation, a processor 108, provides a template having a graphical content pertinent to the subject of the stereoscopic view pair. The template is displayed on at least one of the displays 112, and may be advantageously overlaid contemporaneously with the stereoscopic view pair.

Stereoscopic video camera 109 may include, without limitation, a beam splitter 101 that splits an optical image of the surgical subject 110 into left and right images representing the stereoscopic view pair of subject 110. The left and right images are magnified by magnification-varying optical units 102L and 102R, and focused by lenses 103L and 103R onto imaging devices 104L and 104R, respectively. Imaging devices 104L and 104R, which may include, for example, a Charge-Coupled Device (CCD), convert the left and right optical images into electrical signals 105L and 105R, respectively. Electrical signal 105L is provided to image processor 106L which outputs a video signal 107L representing the left image of the subject, while electrical signal 105R is provided to image processor 106R which outputs a video signal 107R representing the right image of the subject 110. Note that in various embodiments, the stereoscopic camera may include, instead of a beam splitter, two separate cameras that are used to capture the image from two different angles.

The video signals 107L and 107R from stereoscopic camera are fed into a processor 108, which, in part, may perform image signal processing and/or format the signals 107L and 107R so as to drive the one or more displays 112. Processor 108 may include, without limitation, one or more microprocessors, programmable logic arrays, and/or other logic circuits, as known in the art.

Numerous methodologies known in the art may be used in displaying the three dimensional image. For example, and without limitation, a Liquid Crystal Display (LCD) may be placed over a display screen. The LCD produces fast alternating polarization that is synchronized with alternating presentation of the left and right images on the display screen. Also known are systems in which the left and right images are displayed simultaneously, with each image being polarized in a different configuration. For example, the left and right images may be displayed side-by-side.

Typically, a viewer of the display(s) 112, who may be a surgeon, an assistant surgeon, a nurse, an anesthesiologist and/or any other observer, wears special spectacles 113 so that the left eye receives the left image and the right eye receives the right image. The spectacles may be one of many types as known in the art, such as, but not limited to, special polarizing lenses or alternating occlusion lenses. Upon receiving the two images (i.e. the stereoscopic view pair), the viewer's brain triangulates the left and right images, as seen with the left and right eyes, respectively, such that the viewer perceives a three-dimensional image.

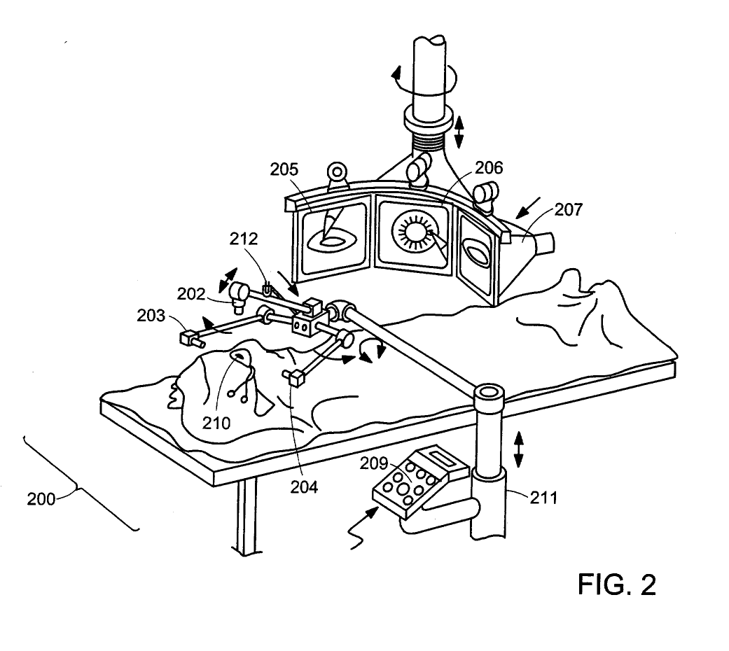

FIG. 2 shows a pictorial view of an operating table equipped with a stereoscopic surgical microscopic system 200, in accordance with one embodiment of the invention. The system includes at least one stereoscopic video camera 202-204. Advantageously, at least two stereoscopic video cameras 202-204 may be provided so that a backup camera is readily available if a camera fails. Each camera 202-204 in the system 200 can be aimed to view the subject 210 from two different directions so as to display different perspectives of the subject 210. This can be particularly relevant in eye surgery, since certain transparent structures of the eye can only be seen if illuminated at specific angles.

Each camera 202-204 may be removably mounted to a boom 211. Boom 211 may include, without limitation, a stand that is adjustable in height, and/or one or more arms that may move in an arbitrary direction. Thus, each camera's position can be properly adjusted so as to provide a desired view of a subject 210. In other embodiments of the invention, the camera(s) may be attached to a headpiece worn by a patient, so as to be focused on, for example, an eye upon which surgery is to be conducted. Thus, the camera(s) will remain focused on the eye regardless of any movement by the patient.

The images from each camera may be selectably displayed on one or more displays 205-207. Each display(s) 205-207 may have a high resolution of, for example, 1280 pixels×1024 pixels or greater. Display(s) 205-207 may be, without limitation, a monitor or a flat-panel display. Multiple images may be displayed on a single display, using, for example, a multi-window operating system.

Through the use of video displays 205-207, the system 200 advantageously provides a larger field of view compared to a traditional operating microscope. With the traditional operating microscope, the size of the viewable field is inversely proportional to the level of magnification. Thus at higher magnifications, the size of the field or view is small. With video system 200, magnification is augmented by the size of the video display(s) 205-207. The optical magnification can be arranged to allow a larger visual field, and then extra magnification of the objects in the field is supplied by a larger display area. The larger display field allows the surgeon to notice potential problems at the periphery of the operative field, an area that may not be seen with a conventional microscope using high magnification.

System 200 may include an operator interface 209. Operator interface 209 provides the surgeon and/or other observer (referred to hereinafter as the “surgeon”) the capability to control various aspects of system 200. For example and without limitation, the surgeon may control, via the operator interface 209, zoom functionality, focusing of cameras 202-204, and/or which camera image or other graphical content is displayed on a particular display. Graphical content on each display may be controlled by software driven menus or taskbars using point and click methodology or other similar means known in the art. Operator interface 209 may include, without limitation, a keyboard, a trackball, a joystick, and/or a mouse. Operator interface may also include a remote control, a foot control that frees the surgeon's hands, and/or one or more memory devices, such as a semiconductor, magnetic, optical or other memory device.

The system 200 includes at least one illumination source 212. The illumination source 212 may be, without limitation, an incandescent bulb that is typically used with traditional operating microscopes. However, incandescent bulbs are subject to burn-out and may need replacement during surgery. Instead of an incandescent bulb, a light-emitting diode (LED) may advantageously be utilized, in accordance with one embodiment of the invention. LEDs typically have a higher reliability than incandescent bulbs, and may function for thousands of hours before failure. Additionally, the reliability of the system can further be improved if a second illumination source is provided, which may be attached to an auxiliary camera.

The illumination source 212 provides enough light to produce a stereoscopic video image. This single image may then be provided and viewed simultaneously on a plurality of displays. Thus, compared to traditional microscopic systems, which typically require an optical beam splitter for each observer, with each beam splitter requiring additional illumination, less illumination is required. This is particularly important in eye surgery. For example, the retina of a patient can be damaged by high light intensity. Note that in various embodiments, the video image generated by the system 200 can be electronically brightened.

Since the illumination used in the system 200 for multiple observers is typically less than that used in traditional microscopic, as described above, and below the level of illumination that can cause damage to the eye, the illumination in the system 200 may be advantageously increased. For example, illumination may be increased (yet remain within safe limits), such that a polarization filter can be placed over the camera lens. The polarization filter eliminates annoying reflections that can create glare and obscure key anatomic features during surgery.

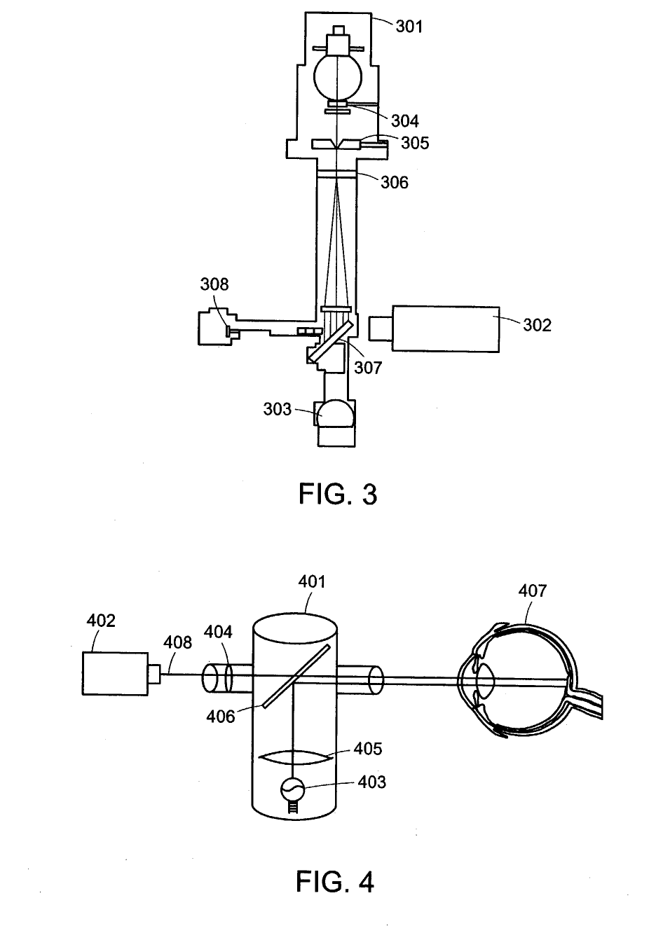

The illumination source 212 may also be a slit lamp or an ophthalmoscope, with the microscope typically used in such systems replaced by a stereoscopic video camera. FIG.3 is a cross-sectional view of a slit lamp 301 used in conjunction with a stereoscopic video camera 302, in accordance with one embodiment of the invention. The slit lamp 301 is used to enhance viewing of many components of the eye 308 that are almost transparent, such as the lens, cornea, aqueous humor, and vitreous body. The slit lamp 301 does this by maximizing the back scattering of light from these various eye components. Typical components of a slit lamp include, for example, a light illumination source 303, a condensing lens 304, a slit 305, a filter tray 306, and a two way mirror 307. An optical output 408 from slit lamp 301 is input into the stereoscopic video camera 402. In various embodiments, the illumination may be enlarged from a slit 305 to a disk to allow an overall view of the eye 308 as well as to allow photography of the eye 308.

FIG. 4 shows a cross-sectional view of an ophthalmoscope 401 used in conjunction with a stereoscopic video camera 402, in accordance with one embodiment of the invention. Using an opthalmoscope, internal structures of the eye 407 may be seen, such as the retina, and the surgeon is able to diagnose various eye disorders and some general conditions, such as diabetes and high blood pressure. The ophthalmoscope 401 provides an optical signal 408 that is input into the stereoscopic video camera 402. Typical components of the opthalmoscope include, for example, a light illumination source 403, two focusing lens 404 and 405, and a two way mirror 406.

The bright illumination from a light-source, such as slit lamp or opthalmoscope, can be annoying to a patient. With the three dimensional video system of the present invention, the video signal representing the stereoscopic view pair may advantageously be stored in memory and analyzed at a later time, so as to minimize the amount of time the eye is illuminated.

Referring back to FIG. 1, to power various components of the system 100 a power source 115 is provided. The power source 115 may be, without limitation, wall current. In other embodiments, one or more system 100 components may be advantageously powered by batteries, which allow continued use of the system in the event of a power outage. The batteries may be rechargeable.

Processor 8 may perform image enhancement on the stereoscopic view pair prior to providing the stereoscopic view pair to the display(s) 112. Image enhancement may include, without limitation, contrast enhancement, zoom capability, electronic brightness control and/or providing special coloring to bring out features such that are difficult to detect with conventional microscopy, such as cataract fibers during cataract removal. Image stabilization may be provided, so as to present a stable image regardless of whether the subject is vibrating or otherwise moving.

In various embodiments of the invention, processor 108 may provide a template that has a graphical content pertinent to the subject of the stereoscopic view pair. The template may be displayed such that the template is overlaid contemporaneously with the stereoscopic view pair. For example, the template may be superposed on, and/or juxtaposed next to, the displayed stereoscopic view pair. All or portions of the template may be displayed so as to be perceived by the viewer in three dimensions. Template may be displayed on display(s) 112 in one or more window(s) in combination with, or separate from, the stereoscopic view pair. For example, and without limitation, the template may be displayed using a split screen and/or picture in picture approach.

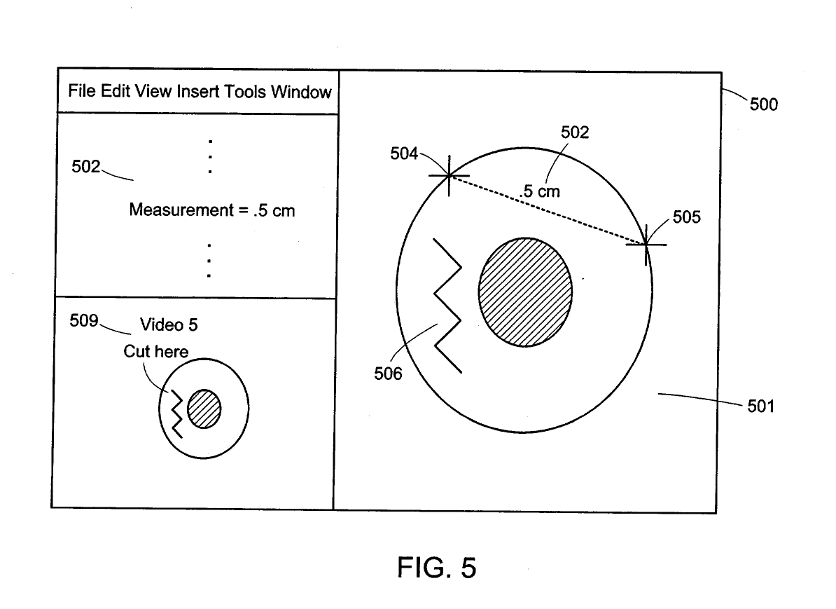

A sample template 500 that incorporates the stereoscopic view pair 501 is shown in FIG. 5 (shown as a two dimensional view for illustrative purposes), in accordance with one embodiment of the invention. The template 500 may provide, without limitation, a measurement(s) 502 related to the displayed stereoscopic view pair 501. For example, the measurement 502 may include an incision length, a size of an anatomical structure, a distance between two anatomical structures, or a position of a structure on a grid superposed on the stereoscopic view. Measurements may accurately be calculated by the processor 8 (see FIG. 1) using various methodologies known in the art. For example, the measurement may be calculated based, at least in part, on the number of pixels between two points to be measured (which can then be multiplied, for example, by a predetermined pixel dimension).

In accordance with one embodiment of the invention, the viewer determines the measurement to be made using at least one cursor 504 and 505 that is overlayed on the displayed stereoscopic view 501. The cursor(s) 504 and 505 may be positioned, selected, and/or otherwise controlled using, for example, the operator interface 209 (see FIG. 2) described above. Processor 8 may overlay the cursor(s) 504 and 505 such that the cursor 504 and 505 is viewed in a stereoscopic manner, as known in the art. Measurements provided by the processor 8 may be stored in memory, providing instant recall and protection against memory loss.

The template 500 may provide changes in elevation pertaining to the displayed stereoscopic view pair. Processor 8 may include, for example, a stereogrammetry program, for measuring the elevation changes. This feature may be used, for example and without limitation, at the close of many ophthalmic operations wherein, after all the sutures have been tightened, sterile fluid is injected into the eye to restore normal intra ocular pressure. If too much fluid is injected into the eye, an abnormally high intra ocular pressure will result, leading to complications. Using the stereogrammetry program, the elevation of the edges of the sutured incision can be followed, allowing any incision gaps to be detected. These gaps indicate that intra ocular pressure is too high and accordingly, some saline should be removed.

In accordance with another embodiment of the invention, the template 500 may provide one or more suturing patterns 506 that can be superposed onto the displayed stereoscopic view pair. The suturing patterns 506 may be stored in memory, and may be operator selectable from a software menu using, for example, operator interface 209 described above. Once selected, the suturing pattern 506 may be superposed on the displayed stereoscopic view 501 and, if desired, further modified. Suturing patterns 506 selected by the viewer may be scalable and may be capable of orientation in any direction. In various embodiments, the viewer may be provided the capability to create new suturing patterns from scratch, which may then be saved into memory. Suturing patterns 506 may be displayed, without limitation, in various colors and/or as a wire fame image, such that the viewer can have a clear view of the subject being worked on. In various embodiments, patterns or markings other than suturing patterns may be superposed onto the displayed stereoscopic view pair, as desired. Markings may be, without limitation, alphanumeric, and/or geometric, such as lines, arrows, and circles, and may be used, for example, to label points of interest.

In other various embodiments of the invention, the template 500 provides surgical guidance. Such guidance may be preprogrammed and/or interpretive. For example, processor 108 may include a collection of selectable videos and/or still images, with each video and/or still image pertaining, without limitation, to an anatomy of healthy or diseased tissue (such as, for example, lesions of the eye), a particular surgical procedure and/or a complication that may arise during surgery. The video(s) may be produced by experienced surgeons. The selected video 509 and/or still image may be displayed in the template 500. If a certain step in an operation needs to be reviewed or if a complication is encountered, the surgeon or other observer can temporarily pause the surgery being performed and play the appropriate portion of video 509 so as to obtain substantially instant expert advice. In other embodiments, the video 509 may be played simultaneously with the on-going surgery, with, for example, the surgeon stepping through the surgery based on instructions provided by the video. The video(s) and/or still images may be stored, without limitation, on tape, DVD, or other suitable recording mediums known in the art. Both graphical material and/or audio material may be presented. Operator interface 209 (see FIG. 2) may provide the capability to quickly play an operator selectable portion of the video 509, such as by accelerating the video backwards or forwards, or jumping to a certain video image(s). Portions of the video signal representative of the stereoscopic view pair and/or the template may also be recorded on the storage medium, for playback during surgery or at a later time. Processor 8 may freeze an image of a particular subject on a display, allowing, for example, the frozen image to be compared with another image that is being displayed in real time.

Other guidance provided by the template 500 may include, without limitation, medical diagnostic advice based on inputs from the surgeon and/or from information that processor 8 obtains directly from the stereoscopic view pair. For example, a surgeon may provide to the processor 8, via the operator interface 209, symptoms, key words, and/or questions. Processor's 8 response to the query may involve various levels of search capability, artificial intelligence, interpretive capability, and/or pattern recognition capability, as known in the art. Using pattern recognition, the processor 8 may, for example, identify various structures and/or diseased parts. Alarms based on an occurrence of a triggering event may be provided. Such alarms may be graphical and/or audio.

Processor 8 may be connected to a network, which may be the Internet. Thus, for example, queries of the surgeon and/or various portions of the video signal representative of a stereoscopic view pair and/or template may be transmitted to various remote locations. Observers and/or processors at the remote location(s) may provide, without limitation, advice, diagnosis, tutorial, pictorial, audio, or video information to processor 8 that can then be presented to the surgeon and/or stored in memory. Communication via the network may occur in real-time, with minimal delay.

Various embodiments of the invention may be implemented as a computer program product for use with a computer system. Such implementation may include a series of computer instructions fixed either on a tangible medium, such as a computer readable media (e.g., a diskette, CD-ROM, ROM, or fixed disk), or fixed in a computer data signal embodied in a carrier wave that is transmittable to a computer system via a modem or other interface device, such as a communications adapter connected to a network over a medium. The medium may be either a tangible medium (e.g., optical or analog communications lines) or a medium implemented with wireless techniques (e.g., microwave, infrared or other transmission techniques). The series of computer instructions embodies all or part of the functionality previously described herein with respect to the system. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web).

The present invention may be embodied in other specific forms without departing from the true scope of the invention. The described embodiments are to be considered in all respects only as illustrative and not restrictive.

What is claimed is:

1. A method of providing visual documentation of a surgical procedure, the method comprising:
providing at least one video camera for generating a video signal in a digital format, the video signal representative of a stereoscopic view pair of a surgical subject;
creating a template having a graphical content pertinent to the subject of the stereoscopic view pair; and
displaying the template overlaid contemporaneously with the stereoscopic view pair.

2. The method according to claim 1, wherein creating the template includes incorporating measurement information pertinent to the surgical subject into the template.

3. The method according to claim 2, wherein incorporating measurement information includes calculating a distance pertinent to the surgical subject.

4. The method according to claim 2, wherein incorporating measurement information includes calculating an elevation pertinent to the surgical subject.

5. The method according to claim 1, wherein creating the template includes incorporating reference material pertinent to the surgical procedure into the template.

6. The method according to claim 5, wherein incorporating reference material includes:
storing a plurality of selectable videos on a storage medium;
selecting one of the plurality of selectable videos; and
incorporating the selected one of the plurality of selectable videos into the template.

7. The method according to claim 6, wherein storing the plurality of selectable videos on a storage medium includes storing the plurality of selectable videos in one of a semiconductor device, an optical device, and a magnetic device.

8. The method according to claim 7, wherein storing the plurality of selectable videos in an optical device includes storing the plurality of selectable videos on one of a Compact Disk and a Digital Versatile Disk.

9. The method according to claim 6, wherein the plurality of selectable videos includes a video that provides a tutorial on the surgical procedure.

10. The method according to claim 6, wherein the plurality of selectable videos includes a video that provides guidance pertaining to a surgical complication that may arise during the surgical procedure.

11. The method according to claim 1, wherein creating the template includes incorporating surgical advice pertinent to the surgical subject into the template.

12. The method according to claim 11, wherein incorporating surgical advice includes providing pattern recognition.

13. The method according to claim 1, wherein creating the template includes incorporating a selectable suturing pattern into the template, the selectable suturing pattern superposed on the stereoscopic view pair.

14. The method according to claim 1, wherein displaying the template overlaid contemporaneously with the stereoscopic view pair includes displaying a plurality of display windows.

15. The method according to claim 1, wherein displaying the template overlaid contemporaneously with the stereoscopic view pair includes displaying the template and the stereoscopic view pair on a plurality of displays.

16. The method according to claim 1, further comprising providing audio pertinent to the surgical subject.

17. The method according to claim 1, further comprising illuminating the surgical subject with a light emitting diode.

18. The method according to claim 1, further comprising illuminating the surgical subject with one of a slit lamp and an ophthalmoscope.

19. A computer program product for providing visual documentation of a surgical procedure, the computer program product comprising a computer usable medium having computer readable program code thereon, the computer readable program including:
program code for receiving a video signal in a digital format from at least one video camera, the video signal representative of a stereoscopic view pair of a surgical subject;
program code for creating a template having a graphical content pertinent to the subject of the stereoscopic view pair; and
program code for displaying the template overlaid contemporaneously with the stereoscopic view pair.

20. The computer program as defined by claim 19, wherein the template includes measurement information pertinent to the surgical subject.

21. The computer program as defined by claim 20, further including program code for calculating a distance pertinent to the surgical subject.

22. The computer program as defined by claim 20, further including program code for calculating an elevation pertinent to the surgical subject.

23. The computer program as defined by claim 19, wherein the template includes reference material pertinent to the surgical procedure.

24. The computer program as defined by claim 19, further including program code for incorporating a selectable video signal into the template.

25. The computer program as defined by claim 24, wherein the selectable video is a tutorial on the surgical procedure.

26. The computer program as defined by claim 24, wherein the selectable video provides guidance pertaining to a surgical complication that may arise during the surgical procedure.

27. The computer program as defined by claim 19, further including program code for incorporating interpretive surgical advice pertinent to the surgical subject into the template.

28. The computer program as defined by claim 27, further including program code for providing pattern recognition pertinent to the surgical procedure into the template.

29. The computer program as defined by claim 19, further including program code for incorporating a selectable suturing pattern into the template, the selectable suturing pattern superposed on the stereoscopic view pair.

30. The computer program as defined by claim 19, further including program code for creating a plurality of display windows used in displaying the template overlaid contemporaneously with the stereoscopic view pair.

31. The computer program as defined by claim 19, further including program code for displaying the template overlaid contemporaneously with the stereoscopic view pair on a plurality of displays.

32. The computer program as defined by claim 19, further including program code for providing audio pertinent to the surgical subject.
